(19) United States
(12) Patent Application Publication
(10) Pub. No.: US 2026/0330279 A1
(43) Pub. Date: Oct. 22, 2026

(54) System and method for orchestrating and securing microservices interactions utilizing quantum-based optimization techniques

(71) Applicant: Bank of America Corporation, Charlotte, NC (US)

(72) Inventors: Jemlin Lucas, Coppell, TX (US); Suryanarayana Adivi, Hyderabad (IN); Pushkar Taneja, Hyderabad (IN)

(21) Appl. No.: 19/180,633

(22) Filed: Apr. 16, 2025

(51) Int. Cl. G06N 10/40; G06N 10/60

(52) U.S. Cl. CPC G06N 10/40; G06N 10/60

(57) ABSTRACT

A system includes a memory and a quantum processor operably coupled to the memory and configured to receive, from a computing device, a request to complete execution of an executable interaction with the software application. For each of the plurality of microservices, the quantum processor is configured to execute a quantum particle swarm optimization (QPSO) algorithm configured to generate and associate with first and second computing systems an autonomous compute agent. The autonomous compute agent is configured to execute directional movements over a plurality of communication paths associated with the first and second computing systems to identify a best communication path. The quantum processor is configured to route, using the identified best communication path, the request to the indicated one of the first computing system or the second computing system and instruct the indicated one of the first computing system or the second computing system to execute the associated microservice.

### TECHNICAL FIELD

The present disclosure relates generally to quantum computing and, more specifically, to a system and method for orchestrating and securing microservices interactions utilizing quantum computing based optimization techniques.

### BACKGROUND

A microservices architecture may include an application built as independent components that run each application process as a component service. Because microservices are independently run, each component service can be updated, deployed, and scaled to meet demand for specific functions of an application. Each component service in a microservices architecture may be developed, deployed, operated, and scaled without affecting the functioning of other component services, and further communication between individual components happens via well-defined application programming interfaces (APIs).

### SUMMARY

The system and methods implemented by the system as disclosed in the present disclosure provide technical solutions to the technical problems discussed above by orchestrating and securing microservices interactions utilizing quantum computing based optimization techniques. The disclosed system and methods provide several practical applications and technical advantages. Specifically, the present embodiments improve the efficiency, latency, and processing speed of orchestrating and facilitating interservice communications between microservices of a microservices architecture and executing executable interactions utilizing the microservices architecture, as well as the one or more processors and memory on which the orchestrated, facilitated, and executed may be executed and stored by orchestrating and securing microservices executable interactions utilizing quantum computing based optimization techniques.

For example, a microservices architecture may include an application built as independent components that run each application process as a component service. Because microservices are independently run, each component service can be updated, deployed, and scaled to meet demand for specific functions of an application. Each component service in a microservices architecture may be developed, deployed, operated, and scaled without affecting the functioning of other component services, and further any communication between individual components happens via well-defined APIs. In one example, a microservices architecture may be utilized to execute one or more distributed executable interactions. Each executable interaction may flow through a sequence of disparate microservices as the executable interaction moves, for example, from request to processing and completion.

Particularly, to complete a single executable interaction, the executable interaction may flow through disparate microservices and respective servers and databases corresponding, for example, to a user authentication microservice, an executable interaction processing microservice, a fraud detection microservice, a compliance, governance and regulatory microservice, a user profile and system of record microservice, a complete executable interaction microservice, and, finally, to a notification microservice. However, due to the generally independent and high-volume operations of the disparate microservices, interservice communications may be difficult to manage and maintain, and may thus lead to increased security vulnerabilities and latency throughout the microservices architecture. For example, during peak periods of operations, the microservices architecture may experience significant decreases in data throughput and execution times and increases in network latency, often leading to increased security vulnerabilities and overall slower executable interaction processing times for individual users.

Accordingly, the present embodiments relate to orchestrating and securing microservices executable interactions utilizing quantum computing based optimization techniques. Specifically, a quantum particle swarm optimization (QPSO) with quantum walks microservices architecture is provided to improve the efficiency, latency, and processing speed of orchestrating and facilitating interservice communications between microservices of a microservices architecture and executing executable interactions utilizing the microservices architecture. For example, upon receiving a request to complete an execution of an executable interaction with a software application, the QPSO with quantum walks microservices architecture may then execute one or more quantum computing based optimization techniques (e.g., QPSO, quantum walks (QWs), combinatorial optimization with QWs) to complete the execution of the executable interaction with the software application.

In one embodiment, the QPSO with quantum walks microservices architecture may execute the one or more quantum computing based optimization techniques (e.g., QPSO, QWs, combinatorial optimization with QWs) for each microservice of a sequence of microservices through which a single executable interaction may flow through to complete the execution of the executable interaction with the software application. For example, in particular embodiments, the QPSO with quantum walks microservices architecture may execute, based on the request, a QPSO algorithm utilized to generate and associate with a number of servers corresponding to a particular microservice an autonomous compute agent (e.g., quantum particle “swarm-intelligence” agent).

In particular embodiments, the autonomous compute agent (e.g., quantum particle “swarm-intelligence” agent) may be utilized to execute one or more directional movements (e.g., QWs, continuous time quantum walks (CTQWs)) over a number of communication paths associated with the number of servers to identify a best communication path of the number of communication paths based on the one or more directional movements (e.g., QWs, CTQWs) and an operational status of each of the number of servers. For example, in one embodiment, the number of communication paths may include a number of wireless communication channels, a number of optical fiber links (e.g., one or more fiber optic cables), or a number of free-space optical links (e.g., photons of light emitted through free space) interconnecting each of the number of servers.

Thus, the autonomous compute agent (e.g., quantum particle “swarm-intelligence” agent) may identify the best communication path to an operational and available server of the number of servers, in which the best communication path is one that satisfies both a low latency constraint and a security level constraint to efficiently and securely execute the particular microservice. The QPSO with quantum walks microservices architecture may then continue executing the one or more quantum computing based optimization techniques (e.g., QPSO, QWs, combinatorial optimization with QWs) for each microservice of the sequence of microservices through which the single executable interaction flows through to complete the execution of the interaction with the software application.

Indeed, by providing the QPSO with quantum walks microservices architecture, the present embodiments may improve the efficiency, latency, and processing speed of orchestrating and facilitating interservice communications between microservices and the executions of executable interactions utilizing microservices. Specifically, as N quantum bits (QuBits) may represent classical binary settings in 2^{N} simultaneously or in parallel, an N-QuBit quantum computing system may simultaneously explore 2^{N} possible solutions or perform 2^{N} simultaneous or parallel searches of the voluminous number of communication paths. Specifically, in classical computing systems, two classical bits can take only one of four states: “00” or “01”; or “10 or “11”. Each of the first bit and the second bit combines to represent only one binary configuration at a given time in a classical computing system, and thus represents a single binary configuration. However, in accordance with the superposition principle of QuBits, one QuBit can exist in multiple states simultaneously.

Thus, the present the QPSO with quantum walks microservices architecture performs parallel processing to improve the efficiency, latency, and processing speed of orchestrating and facilitating interservice communications between microservices and the executions of executable interactions utilizing microservices. That is, instead of the number of possible communication paths being evaluated one by one, the present the QPSO with quantum walks microservices architecture executes the one or more quantum computing based optimization techniques (e.g., QPSO, QWs, combinatorial optimization with QWs) to evaluate all possible communication paths simultaneously by efficiently solving the QPSO optimization algorithm to identify a best communication path that satisfies both a low latency constraint and a security level constraint to efficiently and securely execute each particular microservice of the sequence of microservices utilized to complete the execution of the executable interaction with the software application.

In this way, the QPSO with quantum walks microservices architecture increases processing speed and reduces execution time as compared to any classical computing system alone because the combined classical computing and quantum computing system performs 2^{N} parallel operations to search the voluminous number of communication paths and solve the QPSO optimization algorithm to identify a best communication path. This increased processing speed and reduced latency and execution time further allow the QPSO with quantum walks microservices architecture to route, process, and execute executable interactions within only a few seconds or milliseconds from the time in which a user has initiated an executable interaction (e.g., in real-time).

The present embodiments are directed to systems and methods for orchestrating and securing microservices interactions utilizing quantum computing based optimization techniques. In particular embodiments, a system includes a memory configured to store a software application and a plurality of microservices each associated with a respective plurality of computing systems. In one embodiment, the plurality of microservices comprises a set of independent software services of the software application each configured to be independently executed by one of the respective pluralities of computing systems to complete an execution of an executable interaction with the software application. In one embodiment, each of the respective pluralities of computing systems includes a first computing system and a second computing system.

In particular embodiments, the system includes a quantum processor operably coupled to the memory and configured to receive, from a computing device, a request to complete an execution of an executable interaction with the software application. In particular embodiments, for each of the plurality of microservices, the quantum processor may execute, based at least in part on the request, a quantum particle swarm optimization (QPSO) algorithm configured to generate and associate with the first computing system and the second computing system an autonomous compute agent. In particular embodiments, the autonomous compute agent may be configured to execute one or more directional movements over a plurality of communication paths associated with the first computing system and the second computing system to identify a best communication path of the plurality of communication paths based on the one or more directional movements and an operational status of the first computing system and the second computing system. In one embodiment, the identified best communication path may include an indication of which of the first computing system or the second computing system is suitable to execute the associated microservice in accordance with the request.

In particular embodiments, for each of the plurality of microservices, the quantum processor may be further configured to route, using the identified best communication path, the request to the indicated one of the first computing system or the second computing system to execute the associated microservice. In particular embodiments, for each of the plurality of microservices, the quantum processor may be further configured to instruct the indicated one of the first computing system or the second computing system to execute the associated microservice in accordance with the routed request. In one embodiment, the instruction to execute the associated microservice may include an instruction to advance toward completion the execution of the executable interaction with the software application.

In particular embodiments, the quantum processor may be further configured to generate a QPSO graph based on the plurality of microservices and the plurality of communication paths. In one embodiment, the QPSO graph may include a plurality of nodes each interconnected by a plurality of edges. In one embodiment, the plurality of nodes may include a graph-based representation of the plurality of microservices and the plurality of edges may include a graph-based representation of the plurality of communication paths. In particular embodiments, the autonomous compute agent may include a quantum bit (QuBit). In one embodiment, the QuBit may be configured to execute one or more quantum walks (QWs) over each of the plurality of edges concurrently to identify the best communication path of the plurality of communication paths. In one embodiment, the identified best communication path may include a communication path constrained by a low latency constraint and a security level constraint.

In particular embodiments, the autonomous compute agent may include a quantum bit (QuBit) of a plurality of QuBits, and the quantum processor may be further configured to execute the QPSO algorithm by initializing the QuBit to a first position. In one embodiment, the first position may correspond to a first communication path of the plurality of communication paths. In particular embodiments, the quantum processor may be further configured to execute the QPSO algorithm by deriving a local best position and a global best position for the QuBit based on one or more quantum walks (QWs) of the QuBit from the first position to a second position.

In particular embodiments, the quantum processor may be further configured to execute the QPSO algorithm by evaluating a fitness of the local best position and the global best position for the QuBit and assigning a fitness score to the local best position and a fitness score to the global best position. In response to determining that the fitness score of the global best position satisfies a threshold fitness score, the quantum processor may be further configured to execute the QPSO algorithm by updating the QuBit to the global best position. In one embodiment, the global best position may correspond to the identified best communication path.

In particular embodiments, the plurality of microservices may include two or more of a user authentication microservice, an interaction processing microservice, an interaction gateway microservice, a fraud detection microservice, a governance and regulatory compliance microservice, a user profile microservice, a data value conversion microservice, an audit and logging microservice, or a notification microservice. In particular embodiments, the quantum processor may be further configured to complete the execution of the executable interaction with the software application upon executing the foregoing techniques for each of the plurality of microservices.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a combined classical computing and quantum computing system and network, in accordance with certain aspects of the present disclosure;

FIG. 2 illustrates a diagram of a quantum particle swarm optimization (QPSO) with quantum walks microservices architecture, in accordance with one or more embodiments of the present disclosure; and

FIG. 3 illustrates a flowchart of an example method for orchestrating and securing microservices interactions utilizing quantum computing based optimization techniques, in accordance with one or more embodiments of the present disclosure.

### DETAILED DESCRIPTION

### Example System

### System Overview

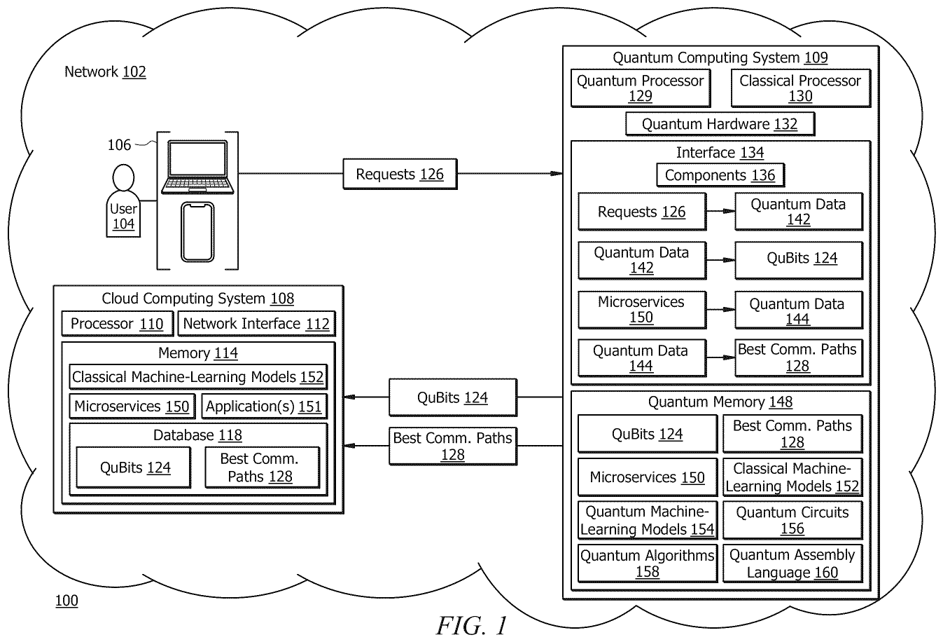

FIG. 1 is a block diagram of a combined classical computing and quantum computing system 100. As depicted, the combined classical computing and quantum computing system 100 may include one or more computing devices 106 that may be associated with a user 104, a cloud computing system 108, a quantum computing system 109, and a network 102 that enables the communications between the one or more computing devices 106, the cloud computing system 108, and the quantum computing system 109. In particular embodiments, the cloud computing system 108 and the quantum computing system 109 may be owned and managed by a single entity or organization, and thus, in some embodiments, the cloud computing system 108 and the quantum computing system 109 may operate in conjunction and/or may be integrated to operate as a singular computing infrastructure. In particular embodiments, the combined classical computing and quantum computing system 100 may be utilized to orchestrate and secure microservices 150 interactions utilizing quantum computing based optimization techniques.

In another embodiment, one of the cloud computing system 108 and the quantum computing system 109 may be owned and managed by the single entity or organization while the other one of the cloud computing system 108 and the quantum computing system 109 may be owned and managed by a third-party entity or organization and licensed to be utilized by the single entity or organization. In one embodiment, the cloud computing system 108 may include a classical computing system suitable for executing binary or bitwise processing operations. In contrast, the quantum computing system 109 may include a quantum computing system suitable for executing superposed and entangled or quantum bit (QuBit) based parallel processing operations.

In general, the present embodiments relate to orchestrating and securing microservices interactions utilizing quantum computing based optimization techniques. Specifically, the quantum computing system 109 is provided to improve the efficiency, latency, and processing speed of orchestrating and facilitating interservice communications between microservices 150 of a microservices 150 architecture and executing interactions utilizing the microservices 150. For example, upon receiving a request 126 to complete an execution of an executable interaction with a software application (e.g., software application(s) 151), the quantum computing system 109 may then execute one or more quantum computing based optimization techniques (e.g., quantum particle swarm optimization (QPSO), quantum walks (QWs), combinatorial optimization with QWs) to efficiently and securely complete the execution of the executable interaction with the software application(s) 151.

As used herein an “interaction” or an “executable interaction” may refer to any sequence of sequential steps that may be executed to exchange data units associated with the user 104 or owned by the user 104 for obtaining for the user 104, for example, one or more data elements (e.g., user obtainable products), one or more data services (e.g., user obtainable services), one or more data units (e.g., user obtainable exchange units), or one or more other data entities that may be desired and obtained by the user 104 via interactions with one or more software application(s) 151. For example, in one embodiment, an “interaction” or an “executable interaction” may include any digital payment transaction requested by the user 104 and executed to obtain for the user 104, for example, a product, a service, a content, an experience, or other partially or wholly exchangeable article that may be desired and obtained by the user 104 via interactions with one or more software application(s) 151.

Similarly, in another embodiment, an “interaction” or an “executable interaction” may include any digital payment transaction flow by which a requested payment transaction is executed by flowing through a sequence of disparate and independent microservices, in which each microservice is executed to act upon a different aspect of the requested payment transaction until the execution of the requested payment transaction is completed. For example, in one embodiment, a sequence of microservices corresponding to a digital payment transaction flow may include a user authentication microservice, an executable interaction processing microservice, an executable interaction gateway microservice, a fraud detection microservice, a compliance, governance and regulatory microservice, a user profile microservice, a value inquiry microservice, a data unit conversion microservice, a notification microservice, an audit logging microservice, a value record microservice, or any of various microservices that may be utilized to efficiently and securely complete the execution of the requested payment transaction.

In accordance with the presently disclosed embodiments, the quantum computing system 109 may execute the one or more quantum computing based optimization techniques (e.g., QPSO, QWs, combinatorial optimization with QWs) for each microservice 150 of a sequence of microservices 150 through which a single executable interaction may flow through to complete the execution of the interaction with the software application(s) 151. For example, in particular embodiments, the quantum computing system 109 may execute, based on the request 126, a QPSO algorithm utilized to generate and associate with a number of servers (e.g., cloud computing system(s) 108) corresponding to a particular microservice 150 an autonomous compute agent (e.g., quantum particle “swarm-intelligence” agents or QuBits 124).

In particular embodiments, the autonomous compute agent (e.g., quantum particle “swarm-intelligence” agents or “swarm” of QuBits 124) may be utilized to execute one or more directional movements (e.g., QWs, continuous time quantum walks (CTQWs)) over a number of communication paths 128 associated with the number of servers to identify a best communication path 128 of the number of communication paths 128 based on the one or more directional movements (e.g., QWs, CTQWs) and an operational status of each of the number of servers (e.g., cloud computing system(s) 108). For example, in one embodiment, the number of communication paths 128 may include a number of wireless communication channels, a number of optical fiber links (e.g., one or more fiber optic cables), or a number of free-space optical links (e.g., photons of light emitted through free space) interconnecting each of the number of servers (e.g., cloud computing system(s) 108).

Thus, the autonomous compute agent (e.g., quantum particle “swarm-intelligence” agents or “swarm” of QuBits 124) may identify the best communication path to an operational and available server (e.g., cloud computing system 108) of the number of servers (e.g., cloud computing system(s) 108), in which the best communication path 128 is one that satisfies both a low latency constraint and a security level constraint to efficiently and securely execute the particular microservice 150. The quantum computing system 109 may then continue executing the one or more quantum computing based optimization techniques (e.g., QPSO, QWs, combinatorial optimization with QWs) for each microservice 150 of the sequence of microservices 150 through which the single executable interaction flows through to complete the execution of the executable interaction with the software application(s) 151.

### Network

Network 102 may be any suitable type of wireless and/or wired network. The network 102 may or may not be connected to the Internet or public network. The network 102 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., WiFi, WiGig, WiMAX, etc.), a long-term evolution (LTE) network, a universal mobile telecommunications system (UMTS) network, a peer-to-peer (P2P) network, a Bluetooth network, a near field communication (NFC) network, and/or any other suitable network. The network 102 may be configured to support any suitable type of communication protocol as would be appreciated by one of ordinary skill in the art.

### Computing Device

Computing device 106 is generally any device that may be utilized to process data and interact with a user 104. Examples of the computing device 106 include, but are not limited to, a personal computer, a desktop computer, a workstation, a server, a laptop, a tablet computer, a mobile phone (such as a smartphone), etc. The computing device 106 may include a user interface, such as a display, a microphone, keypad, or other appropriate terminal equipment usable by the user 104. The computing device 106 may include a hardware processor, memory, and/or circuitry (not explicitly shown) configured to perform any of the functions or actions of the computing device 106 described herein. For example, a software application designed using software code may be stored in the memory and executed by the processor to perform the functions of the computing device 106. The computing device 106 may be utilized to communicate with other components of the system 100 via the network 102.

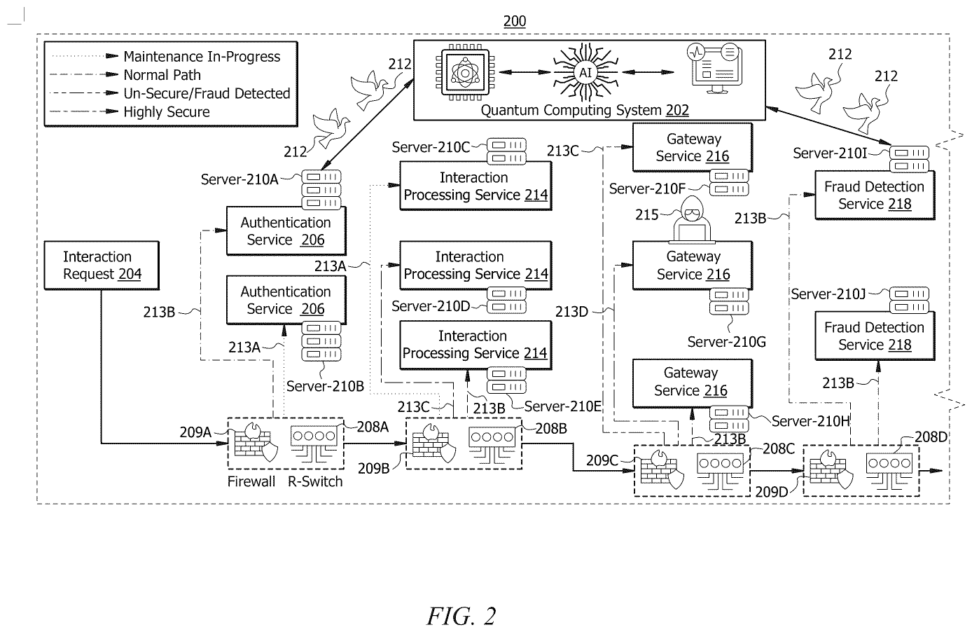

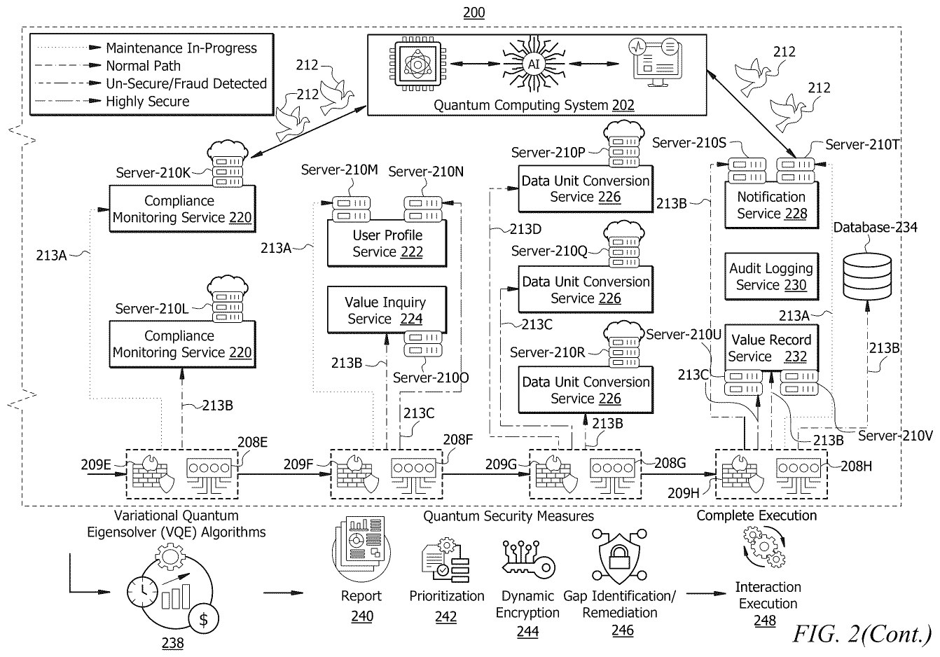

In particular embodiments, the computing device 106 may include a quantum computing device 106 suitable for executing superposed and entangled QuBit based parallel processing operations. For example, in particular embodiments, as will be further discussed below with respect to FIG. 2, the quantum computing device 106 may be utilized by the user 104 to communicate and exchange data over the network 102 to the quantum computing system 109 and/or the cloud computing system 108. For example, the quantum computing device 106 may transmit, over the network 102, one or more requests 126 to the quantum computing system 109. In particular embodiments, the quantum computing system 109 may then encode one or more QuBits 124 representative of the request 126 and may further generate a best communication path 128 for efficiently and securely executing an executable interaction associated with the request 126.

### Cloud Computing System

The cloud computing system 108 may include any computing that may be utilized to process data and communicate with other components of the system 100 via the network 102. In one embodiment, the cloud computing system 108 may include a classical computing system suitable for executing binary or bitwise processing operations. As depicted, the cloud computing system 108 may include a processor 110 in signal communication with a memory 114 and a network interface 112.

Processor 110 may include one or more processors operably coupled to the memory 114. The processor 110 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 110 may be a programmable logic device, a microcontroller, a microprocessor, or any suitable combination of the preceding. The one or more processors 110 may be utilized to process data and may be implemented in hardware or software.

For example, the processor 110 may be 8-bit, 16-bit, 32-bit, 64-bit, or of any other suitable architecture. The one or more processors 110 may be utilized to implement various software instructions to perform the operations described herein. For example, the one or more processors 110 may be utilized to execute software instructions 116 and perform one or more functions described herein. In one embodiment, the processor 110 may be understood to be a classical processor.

Network interface 112 may be utilized to enable wired and/or wireless communications (e.g., via network 102). The network interface 112 is configured to communicate data between the cloud computing system 108 and other components of the system 100. For example, the network interface 112 may include a WIFI interface, a local area network (LAN) interface, a wide area network (WAN) interface, a modem, a switch, or a router. The processor 110 may be utilized to send and receive data using the network interface 112. The network interface 112 may be utilized to use any suitable type of communication protocol as would be appreciated by one of ordinary skill in the art.

Memory 114 may be volatile or non-volatile and may include a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. The memory 114 may store any of the information described in FIGS. 1-3 along with any other data, instructions, logic, rules, or code operable to implement the function(s) described herein. The memory 114 is operable to store software instructions 116, and/or any other data and instructions.

The software instructions 116 may include any suitable set of software instructions, logic, rules, or code operable to be executed by the processor 110. In particular embodiments, the memory 114 may further store a database 118, which may include a structured database (e.g., structured query language (SQL) database, a non-SQL database, or other similar relational database), an unstructured database, a sorted data structure, or an unsorted data structure. In one embodiment, the memory 114 may be understood to be a classical memory. In one embodiment, the memory 114 may include a non-transitory computer-readable medium. In one embodiment, the database 118 may be utilized to store the one or more QuBits 124 and the identified best communication path 128 as one or more classical binary bits of data.

### Quantum Computing System

The quantum computing system 109 may include any quantum computing system that may be utilized to process data and communicate with other components of the system 100 via the network 102 and/or the optical communication channel 133. In one embodiment, the quantum computing system 109 may include a quantum computing system suitable for executing superposed and entangled or quantum bit (QuBit) based parallel processing operations. As depicted, the quantum computing system 109 may include a quantum processor 129, a classical processor 130, and an interface 134 in signal communication with a quantum memory 148.

The quantum processor 129 may include one or more quantum processors operably coupled to the quantum memory 148. The quantum processor 129 is configured to process quantum bits (QuBits). The quantum processor 129 may include a superconducting quantum device (with QuBits implemented by states of Josephson junctions), a trapped ion device (with QuBits implemented by internal states of trapped ions), a trapped neutral atom device (with QuBits implemented by internal states of trapped neutral atoms), a photon-based device (with QuBits implemented by modes of photons), or any other suitable device that implements quantum bits with states of a respective quantum system.

In particular embodiments, the quantum processor 129 may be a quantum processing unit (QPU), which may include a number of quantum registers, a dedicated quantum memory, and a number of quantum logic gates (e.g., a quantum logic gate, a Hadamard logic gate, a Pauli-X logic gate, a Pauli-Y logic gate, a Pauli-Z logic gate, a controlled NOT logic gate, and so forth) suitable for executing superposed and entangled or quantum bit (QuBit) based parallel processing operations.

In particular embodiments, the quantum processor 129 may be further utilized to perform quantum computations, such as quantum annealing, quantum simulations, and universal quantum computing. For example, in particular embodiments, the quantum processor 129 may, in conjunction with the quantum memory 148 and utilizing the quantum hardware 132, execute one or more classical machine-learning (CML) models 152, one or more quantum machine-learning (QML) models 154, one or more quantum circuits 156, one or more quantum algorithms 158, and/or one or more quantum assembly languages 160 for performing operations on the one or more QuBits 124 to generate the best communication path 128 in response to the request 126.

In particular embodiments, the one or more classical machine-learning (CML) models 152 may include, for example, one or more of a spiking neural network (SNN), an autoencoder (AE), a variational autoencoder (VAE), a generative adversarial network (GAN), a convolutional neural network (CNN), a deep neural network (DNN), a deep convolutional neural network (DCNN), a graph neural network (GNN), a graph convolutional network (GCN), a bidirectional and auto-regressive transformer (BART) model, a bidirectional encoder representations for transformer (BERT) model, a generative pre-trained transformer (GPT) model, a graph transformer, a vision transformer (ViT), a diffusion model, or other similar machine-learning model. In another embodiment, the one or more classical machine-learning (CML) models 152 may include one or more language models (LMs) or large language model (LLMs).

Similarly, in particular embodiments, the one or more quantum machine-learning (QML) models 154 may include one or more of a quantum-enhanced machine-learning model, a quantum-inspired machine-learning model, a quantum-generalized machine-learning model, or any of various other machine-learning models in which the processing power of quantum computing and the properties of quantum physics are utilized to accelerate machine-learning tasks. Specifically, it should be appreciated that the quantum computing system 109 may be capable of executing both the one or more classical machine-learning (CML) models 152 and the one or more quantum machine-learning (QML) models 154 in accordance with the presently disclosed embodiments. On the other hand, the cloud computing system 108 may be capable of executing only the one or more classical machine-learning (CML) models 152.

In particular embodiments, the quantum hardware 132 may include, for example, a number of quantum bits (QuBits), a number of QuBit connectors, a number of QuBit interconnector circuits for control operations, and a quantum random access memory (QRAM). The one or more quantum circuits 156 may include a sequence of quantum logic gates suitable for representing and expressing each step of the one or more one or more quantum algorithms 158. For example, the one or more quantum algorithms 158 may include any of various quantum algorithms, such as quantum annealing algorithms, quantum simulation algorithms, quantum search algorithms (e.g., Grover's algorithm), quantum cryptography algorithms (e.g., Shor's algorithm, Deutsch-Jozsa Algorithm, Harrow-Hassidim-Lloyd (HHL) algorithm, Quantum Monte Carlo algorithm, and so forth), one or more quantum Fourier transform (QFT) based algorithms or inverse quantum Fourier transform (iQFT) based algorithms, one or more quantum particle swarm optimization (QPSO) algorithms, one or more quantum walks (QWs) algorithms, one or more classical quantum hybrid algorithms (e.g., Quantum Eigensolver), one or more classical quantum variational algorithms, one or more post-quantum cryptographic algorithms (e.g., quantum-resistant encryption algorithms), and/or other user-developed quantum algorithms that may be represented by instructions.

The classical processor 130 may include one or more processors operably coupled to the quantum memory 148. The classical processor 130 is any electronic circuitry, including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The classical processor 130 may be a programmable logic device, a microcontroller, a microprocessor, or any suitable combination of the preceding. The one or more processors are configured to process data and may be implemented in hardware or software. For example, the classical processor 130 may be 8-bit, 16-bit, 32-bit, 64-bit, or of any other suitable architecture. The one or more processors are configured to implement various software instructions to perform the operations described herein.

The interface 134 may be utilized to convert data items represented by classical binary bits of data into to quantum bits (QuBits) of data. For example, in some embodiments, the interface 134 may convert data packets corresponding to the request 126 represented as classical binary bits of data into quantum data 142 for further processing, and, similarly, convert stored data corresponding to the microservices 150 represented as classical binary bits of data into quantum data 144 for further processing, for example. In particular embodiments, the quantum data 142 and the quantum data 144 may represent one or more QuBits 124.

In particular embodiments, the interface 134 may be further utilized to convert data items represented by quantum bits (QuBits) of data into classical binary bits of data. For example, in particular embodiments, upon the quantum computing system 109 encoding the data packets corresponding to the request 126 based on the quantum data 142, the interface 134 may convert the quantum data 142 representing the one or more QuBits 124 into classical binary bits of data representing the one or more QuBits 124. Likewise, upon the quantum computing system 109 receiving the stored data corresponding to the microservices 150 based on the quantum data 144, the interface 134 may convert the quantum data 144 representing the best communication path 128 into classical binary bits of data representing the best communication path 128.

In particular embodiments, the interface 134 may include a number of components 136 that may be utilized to generate and manipulate the one or more QuBits 124. In the illustrated embodiment, the number of components 136 and the quantum processor 129 are configured to operate on a same type of QuBits 124. For example, when the quantum processor 129 includes a photon-based device (with QuBits implemented by modes of photons), the number of components 136 may include optical components such as lasers, mirrors, prisms, waveguides, interferometers, optical fibers, filters, polarizers, and/or lenses.

In particular embodiments, the number of components 136 may further include one or more quantum-based light sources, such as one or more semiconductor quantum dots (QDs), a high-intensity laser, a quantum particle generator, or other similar quantum-based light source that may be utilized to generate the one or more QuBits 124. In accordance with the presently disclosed embodiments, the number of components 136 may further include a quantum modulator that may be utilized to alter a polarization or a “spin” of the one or more QuBits 124.

Quantum memory 148 may include a quantum read-only memory (QROM), quantum random-access memory (QRAM), or other similar quantum memory. The quantum memory 148 may store any of the information described in FIGS. 1 and 2 along with any other data, such as instructions, logic, rules, or code operable to implement the function(s) described herein. The quantum memory 148 is operable to store software instructions, and/or any other data and instructions. The software instructions may include any suitable set of software instructions, logic, rules, or code operable to be executed by the quantum processor 129. In one embodiment, the quantum memory 148 may include a non-transitory computer-readable medium.

In another embodiment, the quantum memory 148 may include a quantum storage medium, which may be utilized to store the one or more QuBits 124 once generated by the one or more quantum light sources (e.g., semiconductor QDs, high-intensity laser, quantum particle generator). For example, in one embodiment, the quantum memory 148 may include, for example, a cryogenic storage medium, a nitrogen-vacancy (N-V) center in diamond storage medium, one or more rare-earth-ion-doped crystals, one or more quantum dots (QDs), a quantum optical memory (QOM), one or more superconducting QuBits, a controlled reversible inhomogeneous broadening of a single atomic absorption line (CRIB) storage medium, or other similar quantum storage medium.

### Orchestrating and Securing Microservices Interactions Utilizing Quantum Computing Based Optimization Techniques

Embodiments of the present disclosure discuss techniques for orchestrating and securing microservices interactions utilizing quantum computing based optimization techniques.

FIG. 2 illustrates a diagram of a quantum particle swarm optimization (QPSO) with quantum walks architecture 200, in accordance with one or more embodiments of the present disclosure. In one embodiment, the QPSO with quantum walks architecture 200 may be a further illustrative example of the combined classical computing and quantum computing system 100 as described above with respect to FIG. 1. As depicted by FIG. 2, the QPSO with quantum walks architecture 200 may include a quantum computing system 202, a sequence of microservices 206, 214, 216, 218, 220, 222, 224, 226, 228, 230, and 232 that may be executed in response to a request 204, a number of servers 210A-210V that may be utilized to execute the sequence of microservices 206, 214, 216, 218, 220, 222, 224, 226, 228, 230, and 232, a number of combined network router-switches 208A-208H and network firewall devices 209A-209H, and a database 234 (e.g., relational database).

### Quantum Particle Swarm Optimization With Quantum Walks Architecture

As will be discussed in greater detail below, upon receiving a request 204 to complete an execution of an executable interaction with a software application (e.g., software application(s) 151), the QPSO with quantum walks microservices architecture 200 may execute one or more quantum computing based optimization techniques (e.g., QPSO, QWs, combinatorial optimization with QWs) for each microservice of a sequence of microservices (e.g., sequence of microservices 206, 214, 216, 218, 220, 222, 224, 226, 228, 230, and 232) through which a single executable interaction may flow through to complete the execution of the interaction with the software application (e.g., software application(s) 151).

For example, as generally depicted by FIG. 2, to complete a single executable interaction, the executable interaction may flow through a sequence of microservices 206, 214, 216, 218, 220, 222, 224, 226, 228, 230, and 232 (and one or more respective servers 210A-210V), in which each microservice is executed to act upon a different aspect of the executable interaction until the execution of the executable interaction is completed. In particular embodiments, the sequence of microservices 206, 214, 216, 218, 220, 222, 224, 226, 228, 230, and 232 may include, for example, a user authentication microservice 206, an executable interaction processing microservice 214, an executable interaction gateway microservice 216, a fraud detection microservice 218, a compliance, governance and regulatory microservice 220, a user profile microservice 222, a value inquiry microservice 224, a data unit conversion microservice 226, a notification microservice 228, an audit logging microservice 230, and a value record microservice 232.

In particular embodiments, the user authentication microservice 206 may be a microservice suitable for authenticating the user 104 by way of inputted user authentication data, such as a username and password, a digital signature, one or more identification (ID) tokens, one or more access tokens, one or more biometric inputs, or identification data that may be utilized to uniquely identify the user 104. In particular embodiments, the executable interaction processing microservice 214 may be a microservice suitable for processing and handling interactions requested to be executed utilizing executable interaction media, such as a digital card associated with the user 104, a physical card associated with the user 104, a digital interaction profile associated with the user 104, one or more biometric inputs of the user 104, or one or more digital tokens associated with the user 104.

Similarly, the executable interaction gateway microservice 216 may be a microservice suitable for interfacing between an organization hosting the interaction media (e.g., physical card, digital card, digital interaction profile, and so forth) associated with the user 104 and the software application (e.g., software application(s) 151) to which the user 104 is interacting with to facilitate the final execution of the executable interaction. In particular embodiments, the fraud detection microservice 218 may be a microservice suitable for detecting and identifying potential adversarial users 215 and/or potential adversarial user 215 attacks, such as deceptive operations (e.g., “scams,” “spoofing” attacks, phishing attacks, “vishing” attacks, and so forth) that may be executed with respect one or more of the servers 210A-210V.

In particular embodiments, the compliance, governance and regulatory microservice 220 may be a microservice suitable for monitoring and managing permissions, compliance, and regulations with respect to the executable interaction requested by the user 104. The user profile microservice 222 may be a microservice suitable for accessing user profile associated with the user 104 that may be maintained by an organization associated with the software application (e.g., software application(s) 151) to which the user 104 may be interacting. Likewise, the value inquiry microservice 224 may be a microservice suitable for determining a value of data units stored to the user profile of the user 104 and utilized to settle the executable interaction with the software application (e.g., software application(s) 151). The data unit conversion microservice 226 may be a microservice suitable for converting the data units stored to the user profile between different units of measurement.

In particular embodiments, the notification microservice 228 may be a microservice suitable for generating notifications (e.g., push notifications, multimedia messages, emails, and so forth) regarding the executable interaction requested by the user 104. The audit logging microservice 230 may be a microservice suitable for generating and maintaining an audit log of the executable interaction including, for example, a log of the user authentication, a log of the value of the executable interaction, a log of the time of which the request 204 is received, a log of the time of which the execution of the executable interaction is completed, and so forth. The value record microservice 232 may be a microservice suitable for generating and maintaining a report of the requested executable interaction, in which the report may include a complete record of all completed executable interactions that may be associated with the user 104.

In particular embodiments, the sequence of microservices 206, 214, 216, 218, 220, 222, 224, 226, 228, 230, and 232 may each be associated with multiple servers 210A-210V, which may be utilized to execute the sequence of microservices 206, 214, 216, 218, 220, 222, 224, 226, 228, 230, and 232 to perform the functions described above. For example, as further depicted by FIG. 2, the user authentication microservice 206 may be associated with servers 210A and 210B; the executable interaction processing microservice 214 may be associated with servers 210C, 210D, and 210E; the executable interaction gateway microservice 216 may be associated with servers 210F, 210G, and 210H; and so on and so forth.

It should be appreciated that while FIG. 2 illustrates, for example, only 2 or 3 servers 210A-210V for executing each of the sequence of microservices 206, 214, 216, 218, 220, 222, 224, 226, 228, 230, and 232, in implementation, each of the sequence of microservices 206, 214, 216, 218, 220, 222, 224, 226, 228, 230, and 232 may be associated with any number of individual servers 210A-210V (e.g., dozens of individual servers, hundreds of individual servers, or thousands of individual servers). Additionally, it should be appreciated that while the present techniques may be executed for each of the sequence of microservices 206, 214, 216, 218, 220, 222, 224, 226, 228, 230, and 232—for the purposes of illustration and conciseness—the present embodiments may be discussed primarily with respect to the user authentication microservice 206 and associated servers 210A and 210B and/or the executable interaction processing microservice 214 and associated servers 210C, 210D, and 210E.

In particular embodiments, during operations, upon receiving the request 204, the request 204 may be inputted into a combined network router-switch 208A and network firewall device 209A. In one embodiment, the combined network router-switch 208A and network firewall device 209A may include a router or switch that may be utilized to receive the request 204 and route one or more data packets corresponding to the request 204 to the server 210A or the server 210B for executing the user authentication microservice 206. The network router-switch 208A and network firewall device 209A may further include a network security device that may be suitable for controlling the flow of data traffic between the server 210A and the server 210B, for example.

Upon the server 210A or the server 210B executing the user authentication microservice 206, the operations may then continue with the network router-switch 208A and network firewall device 209A receiving a response from the server 210A or the server 210B including data packets corresponding, for example, to user 104 authentication data, which may be then routed to the combined network router-switch 208B and network firewall device 209B. Upon receiving user 104 authentication data, the request 204 along with the user 104 authentication data may be further inputted into the combined network router-switch 208B and network firewall device 209B, which may be utilized to route one or more data packets corresponding to the request 204 and the user 104 authentication data to the server 210C, the server 210D, or the server 210E for executing the executable interaction processing microservice 214. As it may be appreciated, a similar process may be then performed for each of the sequence of microservices 216, 218, 220, 222, 224, 226, 228, 230, and 232 until the execution of the executable interaction associated with the request 204 is completed.

Although not illustrated, in some embodiments, the combined network router-switch 208B and network firewall device 209B may include a large number of communication paths interconnecting the combined network router-switch 208B and network firewall device 209B to any number of servers 210C, 210D, and 210E (e.g., dozens of individual servers, hundreds of individual servers, or thousands of individual servers) that may be associated with the executable interaction processing microservice 214. For example, in one embodiment, the large number of communication paths may include a number of cables (e.g., Ethernet cables), a number of wireless communication channels, a number of optical fiber links (e.g., a number of fiber optic cables), a number of free-space optical links (e.g., photons of light emitted through free space), or other similar communication paths interconnecting the combined network router-switch 208B and network firewall device 209B to the servers 210C, 210D, and 210E. These same such scenarios exist for each of the number of combined network router-switches 208A-208H and network firewall devices 209A-209H.

Thus, in some embodiments, due to the generally independent and high-volume executions of the sequence of microservices 206, 214, 216, 218, 220, 222, 224, 226, 228, 230, and 232, as well as the large number of communication paths interconnecting the number of combined network router-switches 208A-208H and network firewall devices 209A-209H to the number of servers 210A-210V, reliable interservice communications may be difficult to manage, maintain, and operate efficiently. This may thus lead to increased security vulnerability and latency with respect to completing executions of executable interactions in response to requests 204. For example, during peak periods of operations, executions of executable interactions may be subject to significant decreases in data throughput and execution times and increases in network latency, often leading to increased security vulnerabilities and overall slower execution times for requested executable interactions.

Accordingly, it may be useful to provide the quantum computing system 202 to orchestrate and facilitate interservice communications between the sequence of microservices 206, 214, 216, 218, 220, 222, 224, 226, 228, 230, and 232 and further to efficiently execute executable interactions. Specifically, in accordance with the presently disclosed embodiments, upon receiving a request 204 to complete an execution of an executable interaction with a software application (e.g., software application(s) 151), the quantum computing system 202 may execute one or more quantum computing based optimization techniques (e.g., QPSO, QWs, combinatorial optimization with QWs) to securely and efficiently complete the execution of the executable interaction with the software application (e.g., software application(s) 151).

For example, in particular embodiments, upon receiving the request 204, the quantum computing system 202 may execute a the QPSO with QW algorithm utilized to generate and associate with the number of servers 210A-210V a number of autonomous compute agents 212. In one embodiment, a respective autonomous compute agent 212 may be associated with each server of the number of servers 210A-210V. In another embodiment, a respective autonomous compute agent 212 may be associated with each of the set of servers 210A and 210B corresponding to microservice 206, the set of servers 210C, 210D, and 210E corresponding to microservice 214, the set of servers 210F, 210G, and 210H corresponding to microservice 216, the set of servers 210I and 210J corresponding to microservice 218, the set of servers 210K and 210L corresponding to microservice 220, the set of servers 210M and 210N corresponding to microservice 222, the server 210O corresponding to microservice 224, the set of servers 210P, 210Q, and 210R corresponding to microservice 226, the set of servers 210S and 210T corresponding to microservice 228, and the set of servers 210U and 210V corresponding to microservice 232.

In particular embodiments, the number of autonomous compute agents 212 may include a number of quantum particle “swarm-intelligence” agents, such as a number of individual QuBits, a number of individual photons, a number of individual electrons, a number of individual neuronal impulses, a number of individual subatomic particles, or a number of other individual quantum particles that may be suitable for collectively solving the optimization problem of identifying a best communication path 213C of a number of different communication paths 213A, 213B, 213C, and 213D for routing data packets corresponding to the request 204, for example, to one of the server 210C, the server 210D, or the server 210E to execute the interaction processing microservice 216 in accordance with a low latency constraint and a security level constraint.

In particular embodiments, the quantum computing system 202 may execute a the QPSO with QW algorithm, which may include a metaheuristic optimization algorithm combining quantum computing, quantum walks (QWs), and particle swarm optimization (PSO) to efficiently solve optimization problems (e.g., the task of identifying the best solution from a set of possible solutions, which satisfy the constraints defined by the problem). For example, in one embodiment, the number of autonomous compute agents 212 (e.g., quantum particle “swarm-intelligence” agents) may collectively solve the optimization problem of identifying a best communication path 213C of a number of different communication paths 213A, 213B, 213C, and 213D by executing one or more directional movements (e.g., QWs, CTQWs) over each of the number of different communication paths 213A, 213B, 213C, and 213D simultaneously.

Specifically, as part of the QPSO with QW algorithm, the number of autonomous compute agents 212 (e.g., quantum particle “swarm” agents) may each autonomously make quantum mechanical based movements (e.g., QWs, CTQWs) over the number of different communication paths 213A, 213B, 213C, and 213D in accordance with, for example, the social behavior of birds flocking, bees swarming, fish schooling, animals hoarding, and so forth. That is, the number of autonomous compute agents 212 (e.g., quantum particle “swarm-intelligence” agents) may behave both as autonomous agents and as part of a collective group of agents (e.g., a “flock,” a “swarm,” a “school,” a “herd,” and so forth), such that each individual autonomous compute agent 212 moves to its “personal best” position (e.g., representing a candidate best communication path of the number of communication paths 213A, 213B, 213C, and 213D) and ultimately all converge to their collective “global best” position (e.g., representing the best communication path 213C).

Indeed, this “global best” position is thus the solution to the optimization problem of identifying a best communication path 213C of a number of different communication paths 213A, 213B, 213C, and 213D by which to route data packets corresponding to the request 204. Specifically, in accordance with the QPSO with QW algorithm as presently disclosed, each of the number of autonomous compute agents 212 (e.g., quantum particle “swarm-intelligence” agents) has a memory attribute, which allows each autonomous compute agent 212 (e.g., quantum particle “swarm-intelligence” agent) to know and remember its “personal best” position (e.g., representing a candidate best communication path) or the best position it has ever identified while moving over the number of different communication paths 213A, 213B, 213C, and 213D.

Additionally, in accordance with the QPSO with QW algorithm as presently disclosed, each of the number of autonomous compute agents 212 (e.g., quantum particle “swarm-intelligence” agents) has a communication attribute, which allows each autonomous compute agent 212 (e.g., quantum particle “swarm-intelligence” agent) to know the “global best” (e.g., representing a best possible communication path) position or the best position any of the number of autonomous compute agents 212 (e.g., quantum particle “swarm-intelligence” agents) has ever identified while moving over the number of different communication paths 213A, 213B, 213C, and 213D. As previously noted, this “global best” position is the solution to the optimization problem of identifying the best communication path.

In some embodiments, the number of autonomous compute agents 212 may also detect and record operational status data associated with the servers 210C, 210D, and 210E and report the operational status data to the quantum computing system 202. For example, the operational status data associated with the servers 210C, 210D, and 210E may include application programming interface (API) settings, gateway settings, memory usage, CPU usage, latency, data throughput, network bandwidth, software versions, firmware versions, security policies, potential security vulnerabilities, and so forth. In particular embodiments, the quantum computing system 202 may utilize the operational status data associated with the servers 210C, 210D, and 210E to define a set of constraints for the optimization problem of identifying a best communication path 213C of the number of communication paths 213A, 213B, 213C, and 213D for routing data packets corresponding to the request 204.

For example, in one embodiment, the set of constraints may include a low latency constraint and a security level constraint. For example, in some embodiments, the quantum computing system 202 define a low latency constraint, which may include a latency of less than 100 milliseconds (ms), less than 90 ms, less than 80 ms, less than 70 ms, less than 60 ms, less than 50 ms, less than 40 ms, less than 30 ms, less than 20 ms, or less than 10 ms. Similarly, in some embodiments, the quantum computing system 202 define a security level constraint, which may include a network security policy mandating the deployment of adequate network firewall devices; virtual private networks (VPNs); advanced software application security policies; advanced operating system security policies; predetermined authorization, authentication, and encryption for all network users; anti-virus software and malware protection; automatic software patch remediation; and so forth.

In particular embodiments, the number of autonomous compute agents 212 may thus identify a best communication path 213C of the number of communication paths 213A, 213B, 213C, and 213D based on the one or more directional movements (e.g., QWs, CTQWs) and the operational status data associated with the servers 210C, 210D, and 210E, such that the identified best communication path 213C includes not only an indication of the communication path satisfying the low latency constraint and the security level constraint, but also an indication of which of the servers 210C, 210D, and 210E is suitable for executing the interaction processing microservice 216 in accordance with the low latency constraint and the security level constraint.

In particular embodiments, to further orchestrate and facilitate interservice communications between the sequence of microservices 206, 214, 216, 218, 220, 222, 224, 226, 228, 230, and 232, and as a further extension of the QPSO with QW algorithm, the quantum computing system 202 may generate a QPSO graph (e.g., a graph of combinatorial objects) based on the sequence of microservices 206, 214, 216, 218, 220, 222, 224, 226, 228, 230, and 232 and the number of communication paths 213A, 213B, 213C, and 213D. For example, in particular embodiments, the quantum computing system 202 may generate the QPSO graph by modeling each of the sequence of microservices 206, 214, 216, 218, 220, 222, 224, 226, 228, 230, and 232 as nodes of the QPSO graph and the number of communication paths 213A, 213B, 213C, and 213D as edges of the QPSO graph. For example, in one embodiment, the nodes corresponding to the sequence of microservices 206, 214, 216, 218, 220, 222, 224, 226, 228, 230, and 232 may be interconnected by the edges corresponding to the number of communication paths 213A, 213B, 213C, and 213D.

Thus, in accordance with the presently disclosed embodiments, the number of autonomous compute agents 212 (e.g., quantum particle “swarm-intelligence” agents) may further identify a best communication path thorough the nodes corresponding to the sequence of microservices 206, 214, 216, 218, 220, 222, 224, 226, 228, 230, and 232 and the edges corresponding to the number of communication paths 213A, 213B, 213C, and 213D by executing one or more directional movements (e.g., QWs, CTQWs) through the QPSO graph. Thus, in addition to the techniques described above in which the QPSO with QW algorithm is utilized to identify the best communication path (e.g., best communication path 213C) through the sets of servers 210A-210V respectively corresponding to the sequence of microservices 206, 214, 216, 218, 220, 222, 224, 226, 228, 230, and 232, the QPSO with QW algorithm may be further utilized to identify a best communication path through the sequence of microservices 206, 214, 216, 218, 220, 222, 224, 226, 228, 230, and 232 to further efficiently complete the execution of the executable interaction associated with the request 204.

### Quantum Particle Swarm Optimization With Quantum Walks Algorithm

In particular embodiments, the quantum computing system 202 may execute the QPSO with QW algorithm as presently disclosed in accordance with the following process. First, the quantum computing system 202 may initialize a set of QuBits (e.g., a “swarm” of QuBits 124) to respective first positions, in which each first position corresponds to a candidate for best communication path of the number of communication paths 213A, 213B, 213C, and 213D, and, by extension, a candidate solution to the optimization problem of identifying a best communication path.

For example, in one embodiment, the quantum computing system 202 may initialize the set of QuBits (e.g., a “swarm” of QuBits 124) by assigning a random first position to each QuBit of the set of QuBits (e.g., a “swarm” of QuBits 124) and evaluating a fitness function for evaluating a “fitness” or a suitability of each of the random first positions. In one embodiment, the quantum computing system 202 may evaluate the fitness function by generating a respective fitness score (e.g., a value ranging from “0” to “100” or from “0.0” to “1.0” representative a quality of “fitness”) for each of the random first positions. Specifically, the fitness function measures and qualifies how well a QuBit's position represents a best communication path (e.g., best communication path 213C).

In particular embodiments, the quantum computing system 202 may then derive a local best position (e.g., “personal best” position) and a “global best” position for the initialized and evaluated set of QuBits (e.g., a “swarm” of QuBits 124) based on one or more quantum walks (QWs) performed by the initialized and evaluated set of QuBits (e.g., a “swarm” of QuBits 124), for example, from the random first positions to second positions. In particular embodiments, the quantum computing system 202 may then evaluate a “fitness” of the local best position (e.g., “personal best” position) and the “global best” position for the initialized and evaluated set of QuBits (e.g., a “swarm” of QuBits 124).

For example, in one embodiment, the quantum computing system 202 may iteratively evaluate a fitness function for evaluating a “fitness” of each of the second positions for the initialized and evaluated set of QuBits (e.g., a “swarm” of QuBits 124) until a predetermined number of interactions (e.g., Max_{Iterations}) is reached, and further identifying the local best positions (e.g., “personal best” positions) as corresponding to the iteration of second positions resulting in the lowest fitness scores. Similarly, in one embodiment, the quantum computing system 202 may identify the “global best” position for the initialized and evaluated set of QuBits (e.g., a “swarm” of QuBits 124) as corresponding to the one of the random first positions resulting in the lowest overall fitness score.

In particular embodiments, the quantum computing system 202 may then determine whether the “global best” position satisfies a threshold fitness score. For example, in particular embodiments, the quantum computing system 202 may compare the current “global best” position to the current local best positions (e.g., “personal best” positions), which each corresponds to the iteration of second positions resulting in the lowest fitness scores. In one embodiment, the quantum computing system 202 may set the threshold fitness score to the fitness score of the current local best position (e.g., “personal best” position) having the overall lowest fitness score.

Thus, in one embodiment, if the fitness score of the current “global best” position is greater than the threshold fitness score, the quantum computing system 202 may update the current “global best” position to be tantamount to the current local best position (e.g., “personal best” position) having the overall lowest fitness score. In particular embodiments, the quantum computing system 202 may then evaluate a fitness function for evaluating a “fitness” of the updated “global best” position and generate a new fitness score for the updated “global best” position, and the updated “global best” position and the new fitness score may be returned as the best solution to the optimization problem of identifying a best communication path (e.g., best communication path 213C).

### Variational Quantum Eigensolver Algorithms

In particular embodiments, the quantum computing system 202 may also execute a variational quantum eigensolver (VQE) algorithm 238 for further reducing execution time and executable interaction flow computational costs associated with executing the sequence of microservices 206, 214, 216, 218, 220, 222, 224, 226, 228, 230, and 232. For example, the VQE algorithm 238 may be utilized to identify an approximation of the best possible hardware, software, and network configurations (e.g., in terms of quantum circuit structure, server and database usage and capacity, system latency, and so forth) to be assumed by the sequence of microservices 206, 214, 216, 218, 220, 222, 224, 226, 228, 230, and 232 for further facilitating interservice interactions between the sequence of microservices 206, 214, 216, 218, 220, 222, 224, 226, 228, 230, and 232.

For example, in particular embodiments, the quantum computing system 202 may execute the VQE algorithm 238 by 1) generating a set of Hamiltonians representing, for example, executable interactions and computational costs between the sequence of microservices 206, 214, 216, 218, 220, 222, 224, 226, 228, 230, and 232 and 2) designing one or more parameterized quantum circuits (e.g., quantum circuits 156) that may adapt based on executable interaction data and/or the request 204. For example, in particular embodiments, the set of Hamiltonians may include terms representing the computational cost of each executable interaction weighted by their frequency and resource consumption.

In particular embodiments, the one or more parameterized quantum circuits (e.g., quantum circuits 156) may be designed by selecting and deploying one or more ansatz quantum circuits (e.g., quantum circuits 156) appropriately suited to the complexity of the executable interaction and/or the request 204. For example, in one embodiment, the one or more parameterized quantum circuits (e.g., quantum circuits 156) may be designed, such that a hardware-efficient ansatz quantum circuit (e.g., quantum circuit 156) may be utilized to execute simpler operations associated with executing the sequence of microservices 206, 214, 216, 218, 220, 222, 224, 226, 228, 230, and 232 and a unitary coupled cluster ansatz quantum circuit (e.g., quantum circuit 156) may be utilized for more complex operations (e.g., real-time or near real-time simulations, real-time or near real-time software remediations, and so forth) associated with executing the sequence of microservices 206, 214, 216, 218, 220, 222, 224, 226, 228, 230, and 232

In this way, the VQE algorithm 238 may further streamline interservice coordination and interservice communications between the sequence of microservices 206, 214, 216, 218, 220, 222, 224, 226, 228, 230, and 232, and thus leads to overall faster processing and execution times for efficiently completing executable interactions in response to requests 204 having various levels of complexity and/or user-configurable requirements. As further illustrated by FIG. 2, the QPSO with quantum walks architecture 200 may include additional quantum computing based security measures, such as auditing and reporting protocols 240, executable interactions prioritization protocols 242, dynamic encryption protocols 244 (e.g., quantum key distribution (QKD), anomaly detection via quantum algorithms 158), and gap identification and remediation protocols 246. The QPSO with quantum walks architecture 200 may further include final execution hardware, software, and firmware 248, which may be utilized to complete executable interactions.

### Flowchart of Method for Orchestrating and Securing Microservices Interactions Utilizing Quantum Computing Based Optimization Techniques

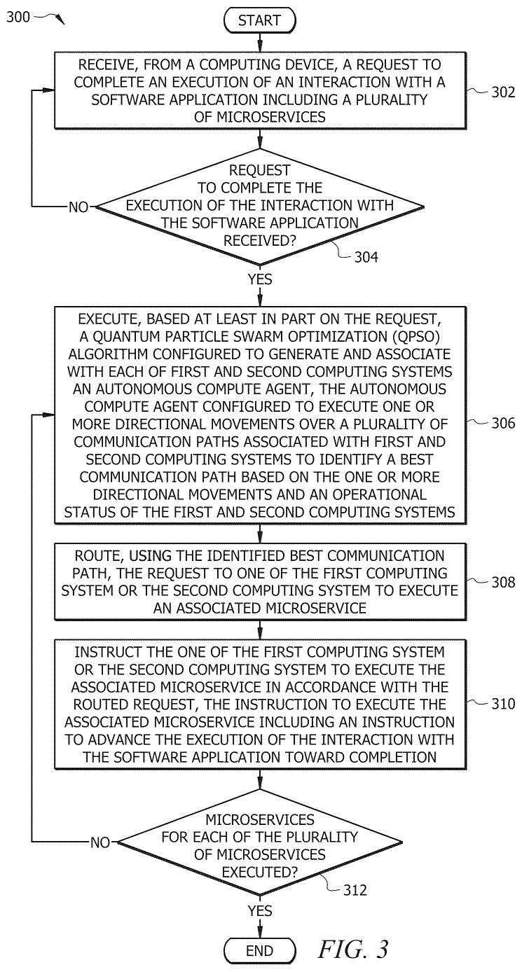

FIG. 3 illustrates a flowchart of an example method 300 for orchestrating and securing microservices interactions utilizing quantum computing based optimization techniques, in accordance with one or more embodiments of the present disclosure. The method 300 may be performed by the combined classical computing and quantum computing system 100 as described above with respect to FIG. 1. For example, in one embodiment, the method 300 may be performed by the quantum computing system 109 alone. In another embodiment, the method 300 may be performed in conjunction by the quantum computing device 106 and the quantum computing system 109.

The method 300 may begin at block 302 with the quantum computing system 109 receiving, from a computing device 106, a request 204 to complete an execution of an executable interaction with a software application (e.g., software application(s) 151). In one embodiment, the software application (e.g., software application(s) 151) may include a sequence of microservices (e.g., microservices 206, 214, 216, 218, 220, 222, 224, 226, 228, 230, and 232) including a set of independent software services each configured to be independently executed by a respective plurality of computing systems (e.g., servers 210D, 210E) to complete an execution of an executable interaction with the software application (e.g., software application(s) 151). The method 300 may continue at decision 304 with the quantum computing system 109 confirming whether the request 204 to complete an execution of an executable interaction with the software application (e.g., software application(s) 151) has been received.

In particular embodiments, in response to confirming that the request 204 to complete an execution of an executable interaction with the software application (e.g., software application(s) 151) has not been received (e.g., at decision 304), the method 300 may return to block 302. On the other hand, in response to confirming that the request 204 to complete an execution of an executable interaction with the software application (e.g., software application(s) 151) has been received (e.g., at decision 304), the method 300 may continue at block 306 with the quantum computing system 109 executing, based on the request 204, a quantum particle swarm optimization (QPSO) algorithm configured to generate and associate with the first computing system (e.g., server 210D) and a second computing system (e.g., server 210E) an autonomous compute agent 212 (e.g., quantum particle “swarm-intelligence” agent).

For example, in one embodiment, the autonomous compute agent 212 (e.g., quantum particle “swarm-intelligence” agent) may be utilized to execute one or more directional movements (e.g., QWs, CTQWs) over a number of communication paths (e.g., 213A, 213B, 213C, and 213D) associated with the first computing system (e.g., server 210D) and the second computing system (e.g., server 210E) to identify a best communication path 213C of the number of communication paths (e.g., 213A, 213B, and 213C) based on the one or more directional movements (e.g., QWs, CTQWs) and an operational status of the first computing system (e.g., server 210D) and the second computing system (e.g., server 210E). In particular embodiments, the identified best communication path 213C may include an indication of which of the first computing system (e.g., server 210D) or the second computing system (e.g., server 210E) is suitable to execute the associated microservice (e.g., executable interaction processing microservice 214) in accordance with the request 204.

In particular embodiments, the method 300 may continue at block 308 with the quantum computing system 109 routing, using the identified best communication path 213C, the request 204 to the indicated one of the first computing system (e.g., server 210D) or the second computing system (e.g., server 210E) to execute the associated microservice (e.g., executable interaction processing microservice 214). The method 300 may then continue at block 310 with the quantum computing system 109 instructing the indicated one of the first computing system (e.g., server 210D) or the second computing system (e.g., server 210E) to execute the associated microservice (e.g., executable interaction processing microservice 214) in accordance with the routed request 204. Specifically, in one embodiment, the instruction to execute the associated microservice (e.g., executable interaction processing microservice 214) may include an instruction to advance toward completion the execution of the executable interaction with the software application (e.g., software application(s) 151).

In particular embodiments, the method 300 may conclude at decision 312 with the quantum computing system 109 confirming whether each of the sequence of microservices (e.g., microservices 206, 214, 216, 218, 220, 222, 224, 226, 228, 230, and 232) has been executed to complete the execution of the executable interaction with the software application (e.g., software application(s) 151). In particular embodiments, in response to confirming that each of the sequence of microservices (e.g., microservices 206, 214, 216, 218, 220, 222, 224, 226, 228, 230, and 232) has not been executed (e.g., at decision 312), the method 300 may return to block 306. On the other hand, in in response to confirming that each of the sequence of microservices (e.g., microservices 206, 214, 216, 218, 220, 222, 224, 226, 228, 230, and 232) has been executed (e.g., at decision 312), the method 300 may complete the execution of the executable interaction with the software application (e.g., software application(s) 151) and terminate (e.g., at block “END”).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store a software application and a plurality of microservices each associated with a respective plurality of computing systems, wherein the plurality of microservices comprises a set of independent software services of the software application each configured to be independently executed by one of the respective pluralities of computing systems to complete an execution of an executable interaction with the software application, and wherein each of the respective pluralities of computing systems comprises a first computing system and a second computing system; and
a quantum processor operably coupled to the memory and configured to:
receive, from a computing device, a request to complete an execution of an executable interaction with the software application; and
for each of the plurality of microservices:
(a) execute, based at least in part on the request, a quantum particle swarm optimization (QPSO) algorithm configured to generate and associate with the first computing system and the second computing system an autonomous compute agent, wherein the autonomous compute agent is configured to execute one or more directional movements over a plurality of communication paths associated with the first computing system and the second computing system to identify a best communication path of the plurality of communication paths based at least in part on the one or more directional movements and an operational status of the first computing system and the second computing system, and wherein the identified best communication path comprises as an indication of which of the first computing system or the second computing system is suitable to execute the associated microservice in accordance with the request;
(b) route, using the identified best communication path, the request to the indicated one of the first computing system or the second computing system to execute the associated microservice; and
(c) instruct the indicated one of the first computing system or the second computing system to execute the associated microservice in accordance with the routed request, wherein the instruction to execute the associated microservice comprises an instruction to advance toward completion the execution of the executable interaction with the software application.

2. The system of claim 1, wherein the quantum processor is further configured to generate a QPSO graph based at least in part on the plurality of microservices and the plurality of communication paths, wherein the QPSO graph comprises a plurality of nodes each interconnected by a plurality of edges, and wherein the plurality of nodes comprises a graph-based representation of the plurality of microservices and the plurality of edges comprises a graph-based representation of the plurality of communication paths.

3. The system of claim 2, wherein the autonomous compute agent comprises at least one quantum bit (QuBit), and wherein the at least one QuBit is configured to execute one or more quantum walks (QWs) over each of the plurality of edges concurrently to identify the best communication path of the plurality of communication paths.

4. The system of claim 3, wherein the identified best communication path comprises a communication path constrained by a low latency constraint and a security level constraint.

5. The system of claim 1, wherein the autonomous compute agent comprises at least one quantum bit (QuBit) of a plurality of QuBits, and wherein the quantum processor is further configured to execute the QPSO algorithm by:
initializing the at least one QuBit to a first position, wherein the first position corresponds to a first communication path of the plurality of communication paths;
deriving a local best position and a global best position for the at least one QuBit based at least in part on one or more quantum walks (QWs) of the at least one QuBit from the first position to a second position;
evaluating a fitness of the local best position and the global best position for the at least one QuBit and assigning a fitness score to the local best position and a fitness score to the global best position; and
in response to determining that at least the fitness score of the global best position satisfies a threshold fitness score, updating the at least one QuBit to the global best position, wherein the global best position corresponds to the identified best communication path.

6. The system of claim 1, wherein the plurality of microservices comprises two or more of a user authentication microservice, an interaction processing microservice, an interaction gateway microservice, a fraud detection microservice, a governance and regulatory compliance microservice, a user profile microservice, a data value conversion microservice, an audit and logging microservice, or a notification microservice.

7. The system of claim 1, wherein the quantum processor is further configured to complete the execution of the executable interaction with the software application upon executing step (a) through step (c) for each of the plurality of microservices.

8. A method, comprising:
receiving, from a computing device, a request to complete an execution of an executable interaction with a software application, wherein the software application comprises a plurality of microservices including a set of independent software services of the software application each configured to be independently executed by a respective plurality of computing systems to complete an execution of an executable interaction with the software application, and wherein each respective plurality of computing systems comprises a first computing system and a second computing system; and
for each of the plurality of microservices:
(a) executing, based at least in part on the request, a quantum particle swarm optimization (QPSO) algorithm configured to generate and associate with each of the first computing system and the second computing system an autonomous compute agent, wherein the autonomous compute agent is configured to execute one or more directional movements over a plurality of communication paths associated with the first computing system and the second computing system to identify a best communication path of the plurality of communication paths based at least in part on the one or more directional movements and an operational status of the first computing system and the second computing system, and wherein the identified best communication path comprises as an indication of which of the first computing system or the second computing system is suitable to execute the associated microservice in accordance with the request;
(b) routing, using the identified best communication path, the request to the indicated one of the first computing system or the second computing system to execute the associated microservice; and
(c) instructing the indicated one of the first computing system or the second computing system to execute the associated microservice in accordance with the routed request, wherein the instruction to execute the associated microservice comprises an instruction to advance toward completion the execution of the executable interaction with the software application.

9. The method of claim 8, further comprising generating a QPSO graph based at least in part on the plurality of microservices and the plurality of communication paths, wherein the QPSO graph comprises a plurality of nodes each interconnected by a plurality of edges, and wherein the plurality of nodes comprises a graph-based representation of the plurality of microservices and the plurality of edges comprises a graph-based representation of the plurality of communication paths.

10. The method of claim 9, wherein the autonomous compute agent comprises at least one quantum bit (QuBit), and wherein the at least one QuBit is configured to execute one or more quantum walks (QWs) over each of the plurality of edges concurrently to identify the best communication path of the plurality of communication paths.

11. The method of claim 10, wherein the identified best communication path comprises a communication path constrained by a low latency constraint and a security level constraint.

12. The method of claim 8, wherein the autonomous compute agent comprises at least one quantum bit (QuBit) of a plurality of QuBits, the method further comprising executing the QPSO algorithm by:
initializing the at least one QuBit to a first position, wherein the first position corresponds to a first communication path of the plurality of communication paths;
deriving a local best position and a global best position for the at least one QuBit based at least in part on one or more quantum walks (QWs) of the at least one QuBit from the first position to a second position;
evaluating a fitness of the local best position and the global best position for the at least one QuBit and assigning a fitness score to the local best position and a fitness score to the global best position; and
in response to determining that at least the fitness score of the global best position satisfies a threshold fitness score, updating the at least one QuBit to the global best position, wherein the global best position corresponds to the identified best communication path.

13. The method of claim 8, wherein the plurality of microservices comprises two or more of a user authentication microservice, an interaction processing microservice, an interaction gateway microservice, a fraud detection microservice, a governance and regulatory compliance microservice, a user profile microservice, a data value conversion microservice, an audit and logging microservice, or a notification microservice.

14. The method of claim 8, further comprising completing the execution of the executable interaction with the software application upon executing step (a) through step (c) for each of the plurality of microservices.

15. A non-transitory computer-readable medium storing instructions that, when executed by one or more quantum processors, cause the one or more processors to:
receive, from a computing device, a request to complete an execution of an executable interaction with a software application, wherein the software application comprises a plurality of microservices including a set of independent software services of the software application each configured to be independently executed by a respective plurality of computing systems to complete an execution of an executable interaction with the software application, and wherein each respective plurality of computing systems comprises a first computing system and a second computing system; and
for each of the plurality of microservices:
(a) execute, based at least in part on the request, a quantum particle swarm optimization (QPSO) algorithm configured to generate and associate with each of the first computing system and the second computing system an autonomous compute agent, wherein the autonomous compute agent is configured to execute one or more directional movements over a plurality of communication paths associated with the first computing system and the second computing system to identify a best communication path of the plurality of communication paths based at least in part on the one or more directional movements and an operational status of the first computing system and the second computing system, and wherein the identified best communication path comprises as an indication of which of the first computing system or the second computing system is suitable to execute the associated microservice in accordance with the request;
(b) route, using the identified best communication path, the request to the indicated one of the first computing system or the second computing system to execute the associated microservice; and
(c) instruct the indicated one of the first computing system or the second computing system to execute the associated microservice to execute the associated microservice in accordance with the routed request, wherein the instruction to execute the associated microservice comprises an instruction to advance toward completion the execution of the executable interaction with the software application.

16. The non-transitory computer-readable medium of claim 15, wherein the instructions further cause the one or more processors to generate a QPSO graph based at least in part on the plurality of microservices and the plurality of communication paths, wherein the QPSO graph comprises a plurality of nodes each interconnected by a plurality of edges, and wherein the plurality of nodes comprises a graph-based representation of the plurality of microservices and the plurality of edges comprises a graph-based representation of the plurality of communication paths.

17. The non-transitory computer-readable medium of claim 16, wherein the autonomous compute agent comprises at least one quantum bit (QuBit), and wherein the at least one QuBit is configured to execute one or more quantum walks (QWs) over each of the plurality of edges concurrently to identify the best communication path of the plurality of communication paths.

18. The non-transitory computer-readable medium of claim 17, wherein the identified best communication path comprises a communication path constrained by a low latency constraint and a security level constraint.

19. The non-transitory computer-readable medium of claim 15, wherein the autonomous compute agent comprises at least one quantum bit (QuBit) of a plurality of QuBits, and wherein the instructions further cause the one or more processors to execute the QPSO algorithm by:
initializing the at least one QuBit to a first position, wherein the first position corresponds to a first communication path of the plurality of communication paths;
deriving a local best position and a global best position for the at least one QuBit based at least in part on one or more quantum walks (QWs) of the at least one QuBit from the first position to a second position;
evaluating a fitness of the local best position and the global best position for the at least one QuBit and assigning a fitness score to the local best position and a fitness score to the global best position; and
in response to determining that at least the fitness score of the global best position satisfies a threshold fitness score, updating the at least one QuBit to the global best position, wherein the global best position corresponds to the identified best communication path.

20. The non-transitory computer-readable medium of claim 15, wherein the plurality of microservices comprises two or more of a user authentication microservice, an interaction processing microservice, an interaction gateway microservice, a fraud detection microservice, a governance and regulatory compliance microservice, a user profile microservice, a data value conversion microservice, an audit and logging microservice, or a notification microservice.
